(19) United States
(12) Patent Application Publication
(10) Pub. No.: US 2023/0234702 A1
(43) Pub. Date: Jul. 27, 2023

(54) AIRCRAFT, PROPELLER ASSEMBLIES, AND METHODS OF MAKING AIRCRAFT

(71) Applicant: Sanmina Corporation, San Jose, CA (US)

(72) Inventor: Gene Lee Watterson, III, Huntsville, AL (US)

(21) Appl. No.: 17/581,565

(22) Filed: Jan. 21, 2022

(51) Int. Cl. B64C 27/48; B64F 5/10

(52) U.S. Cl. CPC B64C 27/48; B64F 5/10; B64C 27/50

(57) ABSTRACT

Aircraft and propeller assemblies may include a propeller adapter with a plurality of propeller blades coupled to the propeller adapter in a common plane. At least one propeller blade of the plurality of propeller blades may be pivotably coupled to the propeller adapter to pivot within the common plane. A spring may be coupled between a portion of the propeller adapter and a portion of the at least one propeller blade pivotably coupled to the propeller adapter. Other aspects, embodiments, and features are also included.

### TECHNICAL FIELD

The technology discussed below relates generally to aerial vehicles, and more specifically to aerial vehicles with a plurality of rotors.

### BACKGROUND

A multirotor or multicopter is a rotorcraft with more than two rotors. An advantage of multicopter aircraft is the simpler rotor mechanics required for flight control. In typical multicopters, control of vehicle motion is achieved by varying the relative speed of each rotor to change the thrust and torque produced by each.

Due to their ease of both construction and control, multicopter aircraft are frequently used in radio control aircraft and unmanned aerial vehicle (UAV) projects in which the names tricopter, quadcopter, hexacopter and octocopter are frequently used to refer to 3-rotor, 4-rotor, 6-rotor, and 8-rotor helicopters, respectively.

UAVs traditionally are stowed or packed for transport to where they are needed. UAVs are generally bulky and fragile to transport in their normal, flight ready state. The propellers, in particular, may be hit, twisted or otherwise damaged, because they extend beyond any other edges on the propeller arms. This creates maintenance hassles and expenses and may prevent timely deployment of the UAV if the damage is only discovered when the UAV is to be deployed.

Features and systems that can improve the operation of multicopter aircraft are generally desirable.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate movement of one or more blades in a propeller between a storage position and a flight position. According to at least one aspect, propeller assemblies are provided. According to one or more embodiments, a propeller assembly may include a propeller adapter. A plurality of propeller blades may be coupled to the propeller adapter in a common plane, and at least one propeller blade of the plurality of propeller blades may be pivotably coupled to the propeller adapter to pivot within the common plane. A spring may be coupled between a portion of the propeller adapter and a portion of the at least one propeller blade pivotably coupled to the propeller adapter.

Additional aspects of the present disclosure include aircraft. According to one or more embodiments, an aircraft may include a frame, and at least one propeller coupled to the frame. The at least one propeller may include a propeller adapter positioned within a common plane, a plurality of propeller blades coupled to the propeller adapter and extending from the propeller adapter within the common plane, where at least one propeller blade of the plurality of propeller blades is pivotably coupled to the propeller adapter to pivot within the common plane. The at least one propeller may further include a spring mechanism coupled between a portion of the propeller adapter and a portion of the at least one propeller blade pivotably coupled to the propeller adapter.

Additional aspects of the present disclosure include methods of making an aircraft. According to at least one implementation, such methods may include coupling a plurality of propeller blades to a propeller adapter in a common plane, where at least one propeller blade of the plurality of propeller blades is pivotably coupled to the propeller adapter to pivot within the common plane. The propeller adapter may be coupled to a frame, and a spring mechanism may be coupled to a portion of the propeller adapter and to a portion of the at least one propeller blade pivotably coupled to the propeller adapter.

Other aspects, features, and embodiments associated with the present disclosure will become apparent to those of ordinary skill in the art upon reviewing the following description in conjunction with the accompanying figures.

### DRAWINGS

FIG. 1 is an isometric view of a simplified multicopter aircraft according to at least one example of the present disclosure.

FIG. 2 is an isometric view of a propeller assembly according to at least one example.

FIG. 3 is a magnified top view of the propeller adapter shown with the propeller blades in the storage position.

FIG. 4 is a top view of the propeller adapter depicted with the rotating sleeves in the storage position.

FIG. 5 is a top view of the propeller adapter depicted with the rotating sleeves in the flight position.

FIG. 6 is a flow diagram illustrating at least one implementation of a method for making an aircraft.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The illustrations presented herein are, in some instances, not actual views of any particular multicopter aircraft, propellers, or other specific components of a multicopter aircraft, but are merely idealized representations which are employed to describe the present disclosure. Additionally, elements common between figures may retain the same numerical designation.

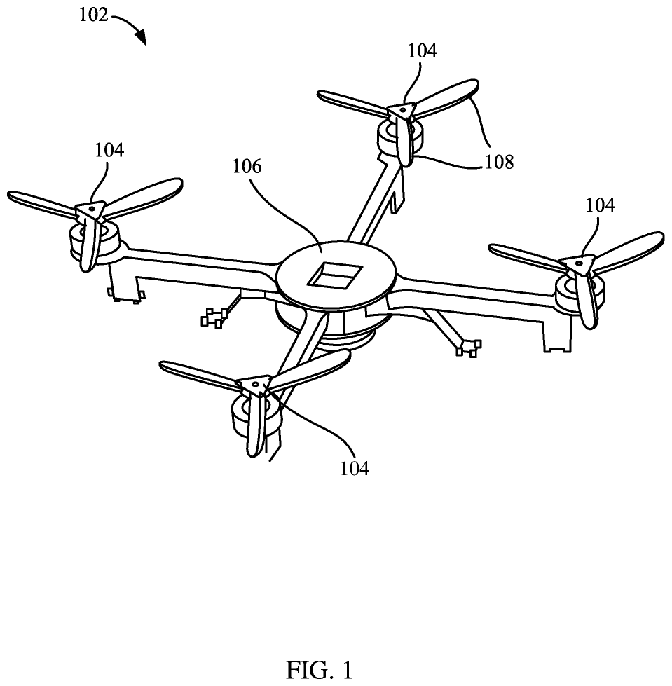

Aspects of the present disclosure relate to aircraft with one or more propellers. Referring to FIG. 1, an example of a simplified multicopter aircraft 102 is depicted according to at least one example. Generally, the multicopter aircraft 102 includes a plurality of rotors or propellers 104 (also referred to as propeller assemblies) coupled to a frame 106. Each propeller 104 may be operably coupled with a motor to spin the propellers 104 in a manner to generate thrust. In some embodiments, a respective motor may be coupled to each respective propeller 104. In other embodiments, a motor may be coupled to more than one propeller 104. Although the frame 106 in FIG. 1 is relatively simple, it should be understood that various embodiments of the present disclosure may employ a plurality of differently shaped and sized frames.

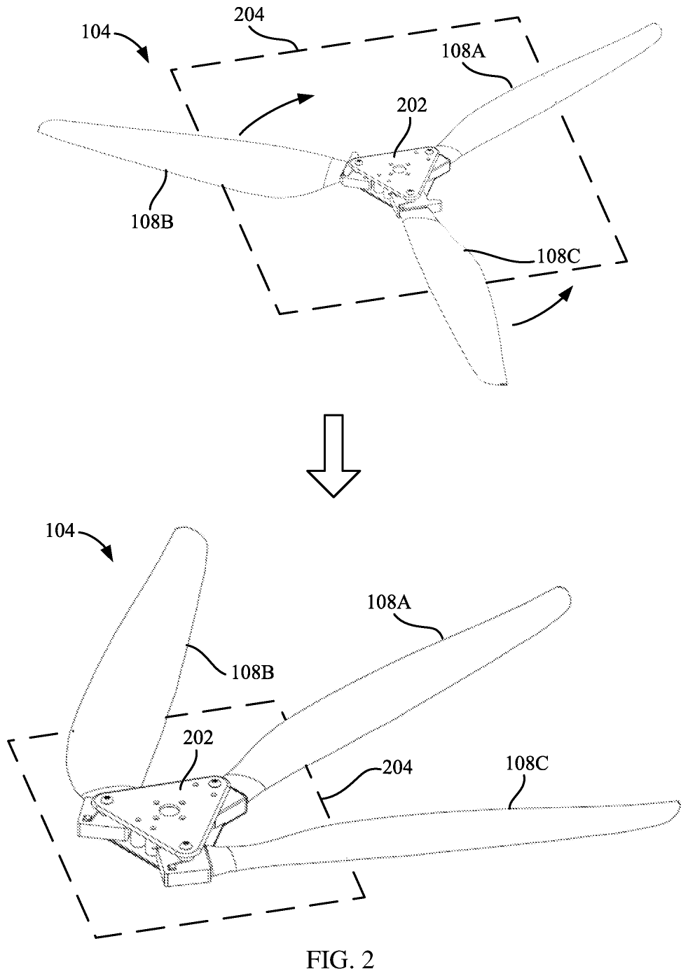

As shown, each propeller 104 includes a plurality of propeller blades 108, with each propeller blade 108 positioned within a common plane. For example, FIG. 2 shows an isometric view of a propeller 104 according to at least one embodiment of the present disclosure. As shown in FIG. 2, the propeller 104 includes a prop adapter 202, which may also be referred to as a propeller adapter 202. A plurality of propeller blades 108 are coupled to the prop adapter 202 in the common plane 204. According to an aspect of the present disclosure, one or more propeller blades 108 of the propellers 104 may be configured to pivot between a flight position depicted in the top image in FIG. 2 when the propeller 104 is rotating for generating lift, and a storage position shown in the bottom image in FIG. 2 when the propeller is not rotating.

More specifically, in the example depicted in FIG. 2, a first propeller blade 108A is fixedly coupled to the prop adapter 202, and the two other propeller blades 108B, 108C are pivotably coupled to the prop adapter 202 within the common plane 204. The two pivotable propeller blades 108B, 108C are configured to pivot within the common plane 204 toward the fixed propeller blade 108A in the direction of the respective arrows depicted in the top image.

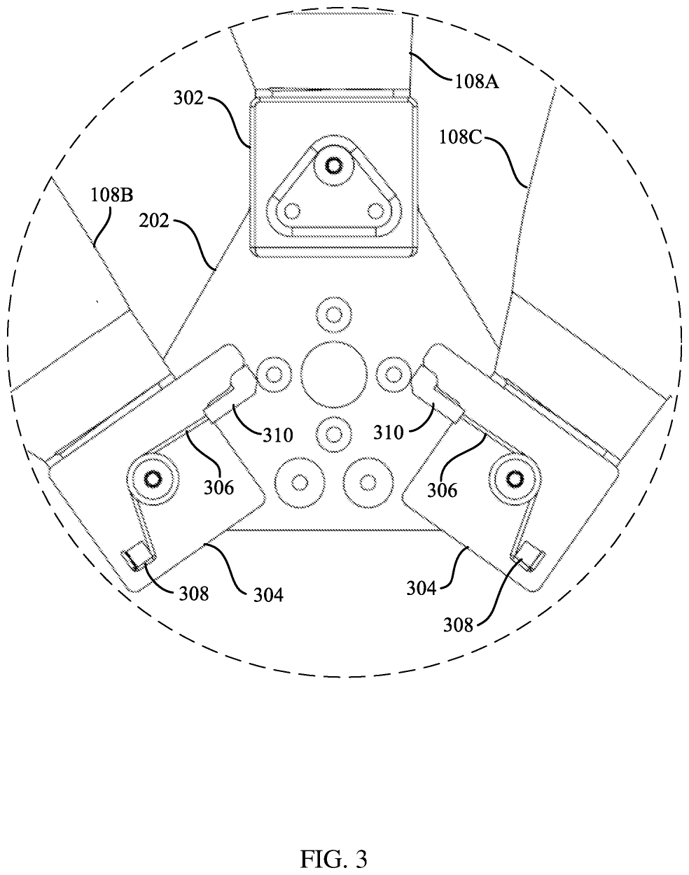

Turning to FIG. 3, a magnified top view of the prop adapter 202 is shown with the propeller blades 108B, 108C in the storage position. In the depicted example of FIG. 3, a cover plate depicted in FIG. 2 of the prop adapter 202 is removed to illustrate an example of the propeller blades 108 coupled to the prop adapter 202. In the depicted embodiment, each propeller blade 108 is coupled to the prop adapter 202 with a blade sleeve. For example, the propeller blade 108A is coupled to the prop adapter 202 with a fixed sleeve 302, while the propeller blades 108B, 108C are coupled to the prop adapted 202 with rotating sleeves 304.

According to one or more embodiments, a spring mechanism 306 may be included, and may be configured to exert a force on the propeller blades 108B, 108C to rotate the propeller blades 108 within the common plane 204 into the storage position. In the example shown in FIG. 3, the spring mechanism 306 is a torsion spring coupled to a first anchor 308 on the rotating sleeve 304 and to a second anchor 310 on the prop adapter 202. Although a torsion spring is depicted in the embodiment of FIG. 3, it should be understood that the spring mechanism 306 could be any type of spring or mechanism that exerts sufficient force to fold the pivotable propeller blades 108B, 108C within the common plane 204 to the storage position when the propeller is not spinning, while also allowing the pivotable propeller blades 108B, 108C to extend outward to the flight position when the propeller is spinning.

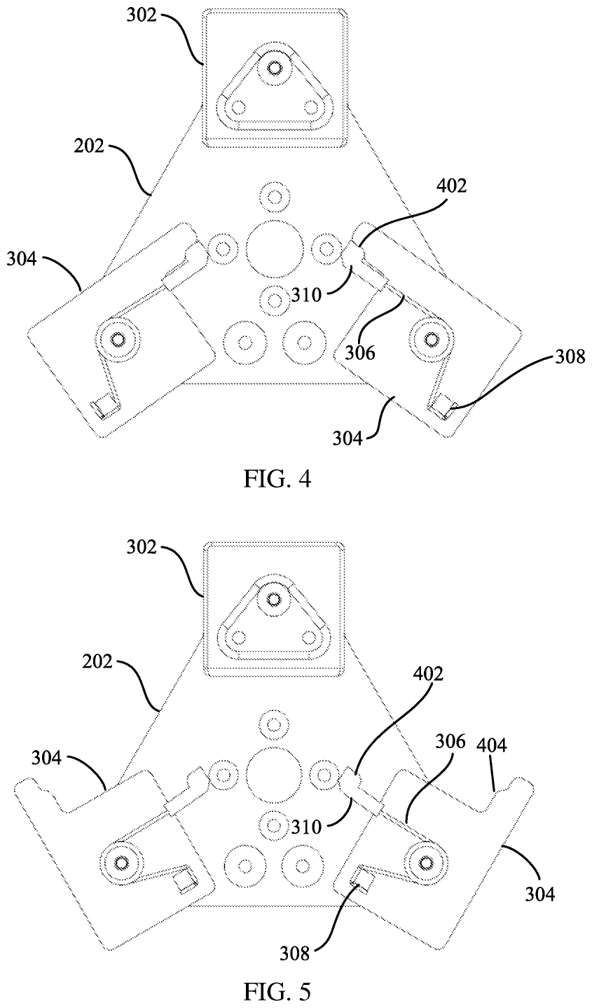

Referring to FIGS. 4 and 5, top views of the prop adapter 202 are depicted with the rotating sleeves 304 in the storage position in FIG. 4 and in the flight position in FIG. 5. As shown, the prop adapter 202 may include a stopping mechanism 402 configured to stop the rotation of the rotating sleeve 304. In the Example in FIGS. 4 and 5, the stopping mechanism 402 includes a protrusion that is incorporated into the second anchor 310 for the spring mechanism 306, although it should be understood that the stopping mechanism 402 and the second anchor 310 can be separate structures in other embodiments of the disclosure. The stopping mechanism 402 is general configured to stop the rotation of the rotating sleeve 304 when the rotating sleeve 304 comes into contact with the stopping mechanism 402. As shown in FIG. 5, the rotating sleeve 304 is in the flight position and is rotated away from the stopping mechanism 402. When the force from the spring mechanism 306 is stronger than the centripetal force extending the propeller blades 108 outward, the spring mechanism 306 rotates the rotating sleeve 304 until a surface 404 of the rotating sleeve 304 contacts the stopping mechanism 402, stopping the rotating sleeve 304 from further rotation.

In operation, the propeller blades 108 pivot or fold co-planar to the common plane 204 in which the propeller blades 108 and the prop adapter 202 are positioned. More specifically, and with reference to FIGS. 2 through 5, when the propeller 104 is rotated to generate lift, centripetal forces on the propeller blades 108 cause the pivotable propeller blades 108B, 108C to overcome the force from the spring mechanism 306 to rotate outward to the flight position shown in the top image of FIG. 2. When the propeller 104 stops rotating, the force from the spring mechanism 306 causes the pivotable propeller blades 108B, 108C to pivot or fold co-planar to each other and to the fixed propeller blade 108A. It should be understood that the spring mechanism 306 will be selected based on the specific application so as to generate sufficient force on the pivotable propeller blades 108 to fold them into the storage position when the propeller 104 is not spinning, while being sufficiently weak enough to be overcome when the propeller 104 spins in use so the pivotable propeller blades 108 pivot to the flight position.

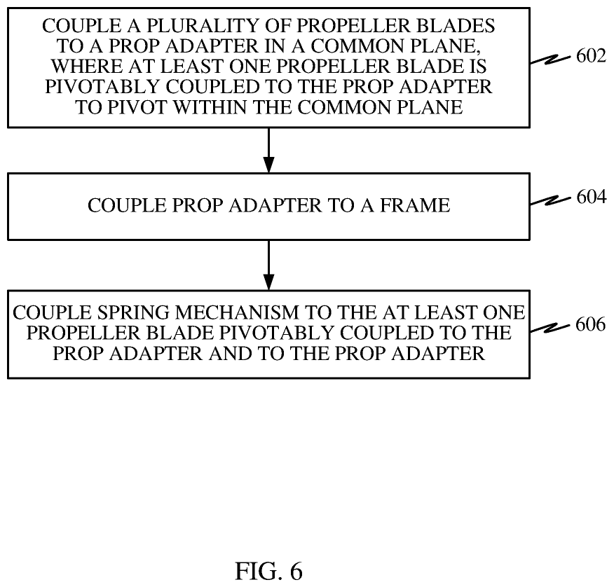

Additional aspects of the present disclosure include methods of making an aircraft, such as aircraft 102. FIG. 6 is a flow diagram depicting at least one example of a method of making an aircraft. With reference to FIGS. 1-6, a plurality of propeller blades 108 may be coupled to a prop adapter 202 within a common plane 204, at operation 602. At least one propeller blade 108B, 108C of the plurality of propeller blades 108 is pivotably coupled to the prop adapter 202 to pivot within the common plane 204. In some implementations, the pivotably-coupled propeller blade 108B, 108C may be coupled to the prop adapter 202 utilizing a rotating sleeve 304. Further, one or more propeller blades 108 not pivotably connected may be coupled to the prop adapter 202 utilizing a fixed sleeve 302.

At 604, the prop adapter 202 may be coupled to the frame 106. For example, the prop adapter 202 may be coupled to the frame 106 to facilitate rotation of the prop adapter 202 and the propeller 104. A moto may further be operably coupled with the prop adapter 202 to spin the propeller 104 in a manner to generate thrust.

At 606, a spring mechanism 306 may be coupled to the at least one propeller blade 108 pivotably coupled to the prop adapter 202 and to the prop adapter 202. In some embodiments, the spring mechanism 306 may be a torsion spring, although other spring mechanisms 306 may be utilized. The spring mechanism 306 may be coupled to a first anchor 308 on the rotating sleeve 304 and to a second anchor 310 on the prop adapter 202. The spring mechanism 306 may be selected to apply a force on the at least one propeller blade 108B, 108C to pivot the at least one propeller blade 108B, 108C within the common plane 204 to a storage position when the plurality of propeller blades 108 are not rotating. Furthermore, the spring mechanism 306 is also selected such that the force applied on the at least one propeller blade 108B, 108C is overcome when the plurality of propeller blades 108 rotate, resulting in the at least one propeller blade 108B, 108C pivoting within the common plane 204 to a flight position when the propeller blades 108 are rotating.

While the above discussed aspects, arrangements, and embodiments are discussed with specific details and particularity, one or more of the components, steps, features and/or functions illustrated in FIGS. 1, 2, 3, 4, 5, and/or 6 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, 4, and/or 5 may be configured to perform or employ one or more of the methods, features, parameters, and/or steps described in FIG. 6. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

1. A propeller assembly, comprising:
a propeller adapter including a stopping mechanism;
a plurality of propeller blades coupled to the propeller adapter in a common plane, wherein at least one propeller blade of the plurality of propeller blades is pivotably coupled to the propeller adapter to pivot within the common plane; and
a spring coupled between a portion of the propeller adapter and a portion of the at least one propeller blade pivotably coupled to the propeller adapter,
wherein the stopping mechanism is positioned to stop the at least one propeller blade pivotably coupled to the propeller adapter from pivoting beyond the stopping mechanism within the common plane in a storage position.

2. The propeller assembly of claim 1, wherein the spring comprises a torsion spring.

3. The propeller assembly of claim 1, wherein the at least one propeller blade pivotably coupled to the propeller adapter includes a rotating sleeve pivotably coupling the at least one propeller blade to the propeller adapter.

4. The propeller assembly of claim 3, wherein the rotating sleeve includes a first anchor, and wherein the spring is coupled to the first anchor.

5. The propeller assembly of claim 1, wherein the spring is configured to exert a force on the at least one propeller blade pivotably coupled to the propeller adapter to pivot the at least one propeller blade within the common plane to a storage position when the propeller assembly is not rotating.

6. The propeller assembly of claim 5, wherein the force exerted by the spring is configured to be overcome in response to rotating the propeller assembly to enable the at least one propeller blade to pivot within the common plane to a flight position when the propeller assembly is rotating.

7. (canceled)

8. An aircraft, comprising:
a frame;
at least one propeller coupled to the frame, the at least one propeller including
a propeller adapter positioned within a common plane and including a stopping mechanism,
a plurality of propeller blades coupled to the propeller adapter and extending from the propeller adapter within the common plane, wherein at least one propeller blade of the plurality of propeller blades is pivotably coupled to the propeller adapter to pivot within the common plane, and
a spring mechanism coupled between a portion of the propeller adapter and a portion of the at least one propeller blade pivotably coupled to the propeller adapter,
wherein the stopping mechanism is positioned to stop the at least one propeller blade pivotably coupled to the propeller adapter from pivoting beyond the stopping mechanism within the common plane in a storage position.

9. The aircraft of claim 8, wherein the spring mechanism comprises a torsion spring.

10. The aircraft of claim 8, wherein the at least one propeller blade pivotably coupled to the propeller adapter comprises a rotating sleeve pivotably coupling the at least one propeller blade to the propeller adapter.

11. The aircraft of claim 10, wherein the rotating sleeve includes a first anchor, and wherein the spring mechanism is coupled to the first anchor.

12. The aircraft of claim 8, wherein the spring mechanism is configured to exert a force on the at least one propeller blade pivotably coupled to the propeller adapter to pivot the at least one propeller blade within the common plane to a storage position when the at least one propeller is not rotating.

13. The aircraft of claim 12, wherein the force exerted by the spring mechanism is configured to be overcome in response to rotating the at least one propeller to enable the at least one propeller blade to pivot within the common plane to a flight position when the at least one propeller is rotating.

14. (canceled)

15. A method of making an aircraft, the method comprising:
coupling a plurality of propeller blades to a propeller adapter in a common plane, wherein at least one propeller blade of the plurality of propeller blades is pivotably coupled to the propeller adapter to pivot within the common plane;
coupling the propeller adapter to a frame; and
coupling a spring mechanism to a portion of the at least one propeller blade pivotably coupled to the propeller adapter and to a portion of the propeller adapter.

16. The method of claim 15, wherein coupling a spring mechanism to a portion of the propeller adapter and to a portion of the at least one propeller blade pivotably coupled to the propeller adapter comprises:
coupling a torsion spring to a portion of the propeller adapter and to a portion of the at least one propeller blade pivotably coupled to the propeller adapter.

17. The method of claim 15, wherein pivotably coupling the at least one propeller blade of the plurality of propeller blades to the propeller adapter comprises:
pivotably coupling the at least one propeller blade to the propeller adapter utilizing a rotating sleeve.

18. The method of claim 17, wherein coupling a spring mechanism to a portion of the at least one propeller blade pivotably coupled to the propeller adapter and to a portion of the propeller adapter comprises:
coupling the spring mechanism to a first anchor on the rotating sleeve and to a second anchor on the propeller adapter.

19. The method of claim 15, wherein coupling a spring mechanism to a portion of the at least one propeller blade pivotably coupled to the propeller adapter and to a portion of the propeller adapter comprises:
coupling the spring mechanism to the at least one propeller blade and the propeller adapter to apply a force on the at least one propeller blade to pivot the at least one propeller blade within the common plane to a storage position when the plurality of propeller blades are not rotating.

20. The method of claim 19, wherein coupling the spring mechanism to the at least one propeller blade and the propeller adapter to apply a force on the at least one propeller blade comprises:
coupling the spring mechanism to the at least one propeller blade and the propeller adapter to apply the force on the at least one propeller blade to be overcome in response to rotating the plurality of propeller blades to enable the at least one propeller blade to pivot within the common plane to a flight position when the plurality of propeller blades are rotating.
